(19) United States
(12) Patent Application Publication
(10) Pub. No.: US 2015/0127631 A1
(43) Pub. Date: May 7, 2015

(54) BEST AVAILABLE ALTERNATIVE DIALOG

(71) Applicant: International Business Machines Corporation, Armonk, NY (US)

(72) Inventors: Rangachari Anand, Teaneck, NJ (US); Juhnyoung Lee, Yorktown Heights, NY (US); Rong Liu, Sterling, VA (US); Kohtaroh Miyamoto, Tokyo (JP)

(73) Assignee: INTERNATIONAL BUSINESS MACHINES CORPORATION, Armonk, NY (US)

(21) Appl. No.: 14/071,866

(22) Filed: Nov. 5, 2013

(51) Int. Cl. G06F 17/30

(52) U.S. Cl. CPC G06F 17/30864
USPC 707/722

(57) ABSTRACT

Recommending problem resolution knowledge, in one aspect, may comprise determining a given product information associated with a product by searching an information network. The given product information may comprise a type of the given product, one or more features associated with the given product, and temporal information associated with the given product. One or more related products may be retrieved from the knowledge base. Related product information associated with each of the one or more related products may be determined, e.g., by searching the information network. At least one related product is selected that has the related product information that most closely matches the given product information. A dialog network from the knowledge base associated with the at least one related product is presented for the problem resolution of the given product.

### FIELD

The present application relates generally to computers, and computer applications, and more particularly to Information Technology (IT) Service Management and Incident Management.

### BACKGROUND

In IT incident management, previously used information may be utilized to solve an incoming problem associated with a product such as a computer application. However, a given product might not have an existing knowledge base associated with it, from which to determine and recommend a solution. The present disclosure, in one aspect, finds a dialog in a knowledge base for the incoming problems that might not be directly covered in the existing knowledge base.

### BRIEF SUMMARY

A method for recommending problem resolution knowledge, in one aspect, may comprise receiving an identifier associated with a given product for a problem resolution, wherein the problem resolution associated specifically with the given product is not available in a knowledge base that comprises a network of dialogs established for problem resolutions. The method may also comprise determining given product information associated with the given product by searching an information network based on the identifier associated with the given product, and further determining reliability associated with the given product information, the given product information comprising a type of the given product, one or more features associated with the given product, and temporal information associated with the given product. The method may also comprise retrieving from the knowledge base one or more related products determined to be related to the given product. The method may further comprise determining related product information associated with each of the one or more related products, and reliability associated with the related product information, the related product information comprising a type of the related product, one or more features associated with the related product, and temporal information associated with the related product. The method may also comprise selecting at least one of said one or more related products that has the related product information that most closely matches the given product information. The method may also comprise presenting a dialog network from the knowledge base for the problem resolution associated with the given product, the dialog network associated with said at least one of said one or more related products.

A system for recommending problem resolution knowledge, in one aspect, may comprise

a knowledge base storing a network of dialogs for problem resolutions. The system may also comprise a main process handler module operable to execute on a processor, and further operable to receive an identifier associated with a given product for a problem resolution, wherein the problem resolution associated specifically with the given product is not available in the knowledge base. The main process handler module may be further operable to retrieve from the knowledge base one or more related products determined to be related to the given product. An information and reliability calculation module coupled to the main process handler module may be operable to execute on the processor, the information and reliability calculation module may be further operable to determine given product information associated with the given product by searching an information network based on the identifier associated with the given product, and reliability associated with the given product information, the given product information comprising a type of the given product, one or more features associated with the given product, and temporal information associated with the given product. The information and reliability calculation module further may be operable to determine related product information associated with each of the one or more related products, and reliability associated with the related product information, the related product information comprising a type of the related product, one or more features associated with the related product, and temporal information associated with the related product. An information matching module coupled to the main process handler module may be operable to execute on the processor, the information matching module further operable to select at least one of the one or more related products that has the related product information that most closely matches the given product information. The main process handler module may be further operable to present a dialog network from the knowledge base for the problem resolution associated with the given product, the dialog network associated with the at least one of the one or more related products.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 illustrates an overall process flow of a method in one embodiment of the present disclosure for determining an available alternate dialog.

FIG. 2 illustrates in one embodiment a method for application information retrieval and reliability calculation.

FIG. 3 illustrates in one embodiment a method for application information retrieval and reliability computation.

FIG. 4 illustrates dialog exploration in one embodiment of the present disclosure.

FIG. 5 is a diagram illustrating a system for determining a best available dialog in one embodiment of the present disclosure.

FIG. 6 shows a structure of a dialog knowledge base in one embodiment of the present disclosure.

FIG. 7 illustrates a schematic of an example for recommending the best available match in the knowledge base in one embodiment of the present disclosure.

FIG. 8 is a diagram that illustrates an overview of an example dialog manager.

FIG. 9 illustrates a sample dialog that may be built and/or used in a dialog manager.

FIG. 10 illustrates an example dialog manager system.

FIG. 11 illustrates a general overview of an example context in which a methodology of the present disclosure may be employed.

FIG. 12 shows a sample histogram showing frequency of different temporal information obtained from a search.

FIG. 13 illustrates a schematic of an example computer or processing system that may implement a system for finding an available dialog for resolving a problem in one embodiment of the present disclosure.

### DETAILED DESCRIPTION

A Dialog Manager may be utilized to author and reuse problem resolution content. Methods and systems are provided that can add to the Dialog Manager, and which in this disclosure, allows for finding the right dialog in knowledge base for the incoming ticket, even when the resolution of the problem is not directly covered in the current Dialog Manager Knowledge Base (DM KB), e.g., to improve the performance of the Dialog Manager.

A methodology of the present disclosure in one embodiment may (1) match problem ticket information to the right dialog in the DM KB for resolution, (2) find whether certain categories and sub-categories of problems are covered or not covered in the DM KB, and (3) for a problem not currently covered in the DM KB, recommend the most relevant dialog in the DM KB for user navigation by, e.g., using metadata from various sources, calculating the reliability score with domain reliability and temporal deviation, and recommending the nearest, the most reliable, available dialog in the DM KB by using the calculated score. A methodology of the present disclosure in one embodiment may also augment the dialog knowledge base with the right content in addition to finding the right dialog in the knowledge base for an incoming problem ticket.

IT Service Management (ITSM) concerns customer's perspective of IT's contribution to the business. Incident Management involves an IT service management (ITSM) process area. For instance, an objective in Incident Management may be to restore a normal service operation as quickly as possible and to minimize the impact on business operations, thus ensuring that the best possible levels of service quality and availability are maintained. An incident may be any event which is not part of the standard operation of a service and which causes, or may cause, an interruption to or a reduction in, the quality of that service. Information Technology Infrastructure Library (ITIL) may include a set of practices for ITSM that focuses on aligning IT services with the needs of business. ITIL may describe procedures, tasks and checklists that are not organization-specific, used by an organization for establishing a minimum level of competency. A stated ITIL objective may be to restore normal operations as quickly as possible with the least possible impact on either the business or the user, at a cost-effective price.

Software is becoming more and more complex, and maintenance business is growing rapidly. Sharing the procedural knowledge in frequently asked question (FAQ) system such as the Dialog Manager may reduce the cost of maintenance. The Dialog Manager may include high quality of structured data in its knowledge base, and the user interface to effectively disseminate the content. Dialogs for problem resolution in knowledge base may be updated over time, e.g., when the maintenance work and/or the Dialog Manager needs to cover new items such as for new software releases, new categories/sub-categories, new work areas, new components, etc. Updating dialogs manually is very labor intensive and can be very costly.

Dialogs describe procedures, for example, for resolving problems, related to specific hardware or software. Examples of dialogs may include “Reset SAP job queue for warehouse management V7.4”, “Diagnose problems in version 1.7 of ATM hardware.” SAP refers to an enterprise resource planning application from SAP AG, Germany. ATM refers to asynchronous transfer mode. As new versions of hardware and software are released, the corresponding dialog content should also be updated to reflect new requirements. In addition, it may be necessary to keep older versions of a dialog even when creating a new version. For example, even when a Windows 7™ version of a software package is released, some users may still be using the older Windows XP™ version. Windows 7™ and Windows XP™ are operating systems from Microsoft Corporation, Remond, Wash.

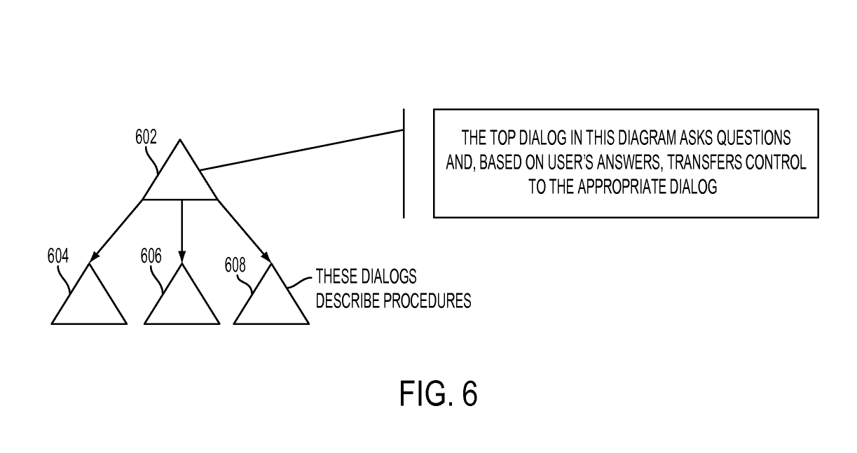

Locating or finding the right dialog for a specific problem from a large dialog set (knowledge base) may be difficult. The Dialog Manager currently provides two ways to help users locate dialogs: text search; using dialogs themselves as a kind of search engine using inter-dialog links. FIG. 6 shows a structure of a dialog knowledge base in one embodiment of the present disclosure. The structure may contain a hierarchical tree structure of elements or nodes. The top dialog element 602 (also referred to as a node) comprises a question and next levels of nodes may contain answers or procedure or additional questions. Based on the answer to the question contained in the top dialog node 602, control is transferred to an appropriate dialog node 604, 606 or 608 via the edges (links). Such structure may be also referred to as a dialog network or a dialog network of frequently asked questions, in the present disclosure.

In the present disclosure in one embodiment, a new dialog search method is presented. The method may in one embodiment associate metadata with dialogs, determining the best format to store of the metadata. Example format for metadata includes name/value text string pairs. Such metadata could be used to specify the applicability of a dialog. For example, a dialog's metadata might specify, “This dialog applies to an XYZ warehouse management system version 7.5,” XYZ being a particular product, for example, a particular enterprise resource planning application. Enterprise resource planning application generally refers to business management software that utilizes integrated applications to manage the business operations such as product planning and development, manufacturing, marketing and sales. The Dialog Manager or the like in the present disclosure may then automatically create a kind of a decision tree to help users locate the correct dialog with a minimum number of questions.

If a dialog is missing for a specific procedure that a user is looking for, the method may return the best available match. Consider, for example, a user who is looking for a password reset procedure for a particular version of an operating system. Further, consider that in this example, a dialog containing a procedure for password reset on a different version of the same operating system is available, but not for the particular version. A method in one embodiment of the present disclosure may generate a dialog candidate. In this example, a dialog candidate may include the dialog containing a procedure for password reset on that different version of the operating system that is available.

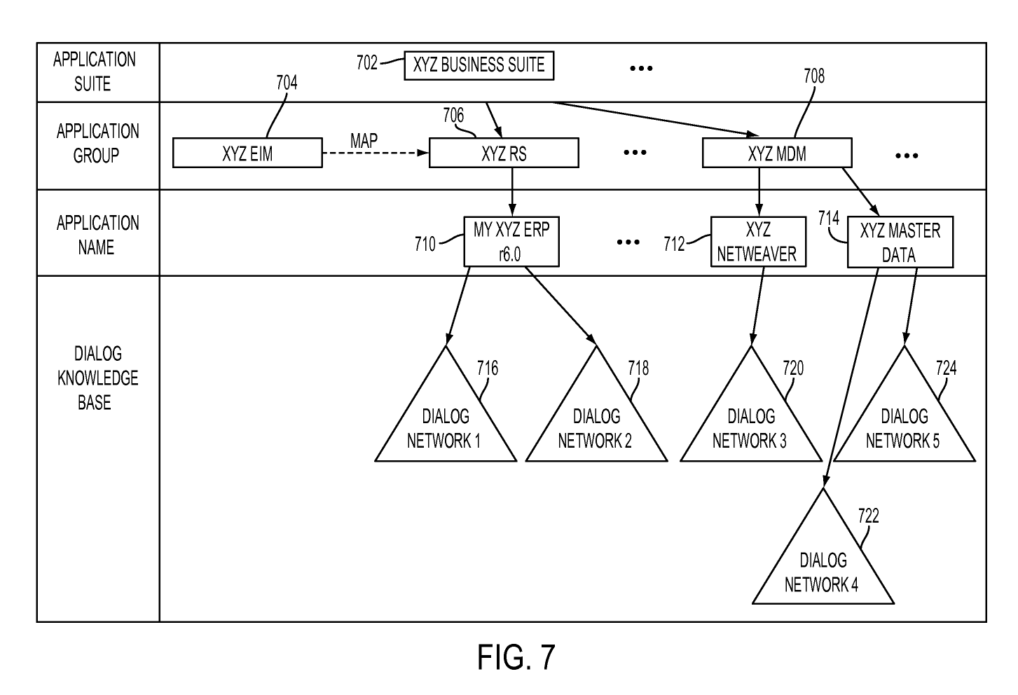

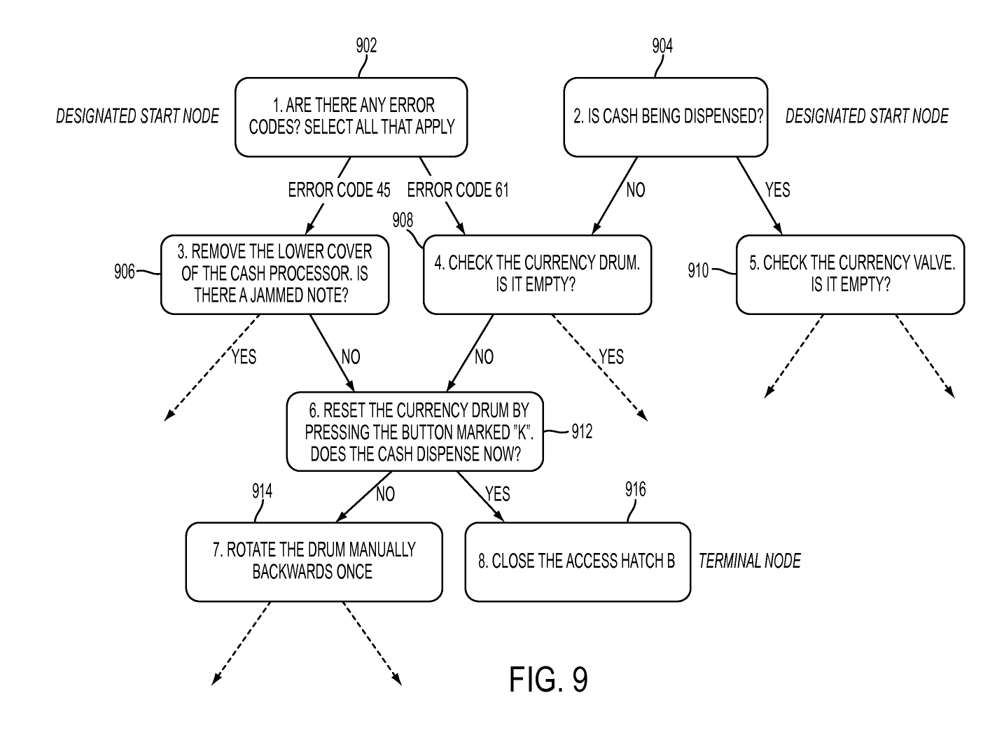

FIG. 7 illustrates a schematic of an example for recommending the best available match in the knowledge base in one embodiment of the present disclosure. Consider an enterprise resource planning application suite, XYZ 702. Consider also that the suite's application groups comprise, among others, an enterprise information management (EIM) application, RS (Resource System), and master data management (MDM) application. Consider further that dialog knowledge base exists that is associated with application names, “myXYZ ERP r6.0” 710 corresponding to an RS application 706, “XYZ netweaver” 712 corresponding to an integration application 708, and “XYZ Master Data” 714 corresponding to a master data management (MDM) application 708. For instance, there may be two dialog networks 716 and 718 related to application, “myXYZ ERP r6.0” 710; there may be a dialog network 720 related to “XYZ netweaver” application 712; there may be two dialog networks 722 and 724 related to “XYZ Master Data” application 714. An example dialog network is shown in FIG. 9. In the example shown in FIG. 7, a user may be looking for a dialog associated with XYZ EIM application 704, where no dialog knowledge base exists specifically for that application. A method of the present disclosure in one embodiment determines and provides a dialog candidate that is considered a best available alternative.

To select a dialog candidate, the method in one embodiment of the present disclosure may consider the following factors. The factors are generally described with reference to an application. However, such factors may apply also to other products generally, e.g., computer hardware products and other products. Hence, the methodologies of the present disclosure are not limited to applications concerning software applications. For example, a dialog candidate may be selected for resolving questions or problems associated with products other than applications.

Referring to factors considered for selecting a dialog candidate, applications can generally be grouped by its type (e.g., enterprise resource planning (ERP), Middleware, Spreadsheet) and feature (e.g., user authentication, text analysis, hypertext markup language (HTML) output). However, there is usually not any or enough information about such information in the tickets, or the like, that describe problems or questions. Applications are also strongly correlated to product release timing (temporal) information, e.g., versions that are released in closer time proximity are more strongly correlated (e.g., an operating system (OS) version Z released within two years of version Y is strongly correlated to version Y, more than to version X released five years after version Z). Also, operations such as print, save, drag and drop, copy and paste are common among certain application types (e.g., word processor type, spreadsheet type). Further, applications can have multiple release dates, e.g., service packs or minor releases. Internet can be treated as a database to gather information but its information is not necessarily reliable. A method in one embodiment of the present disclosure may match unknown node (application or product) information to its most relevant available dialog in a knowledge base by matching the type, feature and temporal information obtained, e.g., from the internet and/or other available sources automatically taking into account their reliability.

The nodes shown in FIG. 7 may be stored in a computer system as one or more of computer data files or objects. It can also reside on a different computer system connected by network. Information about applications or products that are related and their relation types may be also stored as a data structure (702, 704, 706, 708, 710, 712). In another embodiment, such information may be dynamically obtained from available resources such as the Internet or another database. For instance, two or more applications (or products) may be considered to be related, e.g., if they are different versions or releases of a given application or product; e.g., if two or more applications (or products) are of the same type; e.g., if two or more applications are part of the same suite of applications.

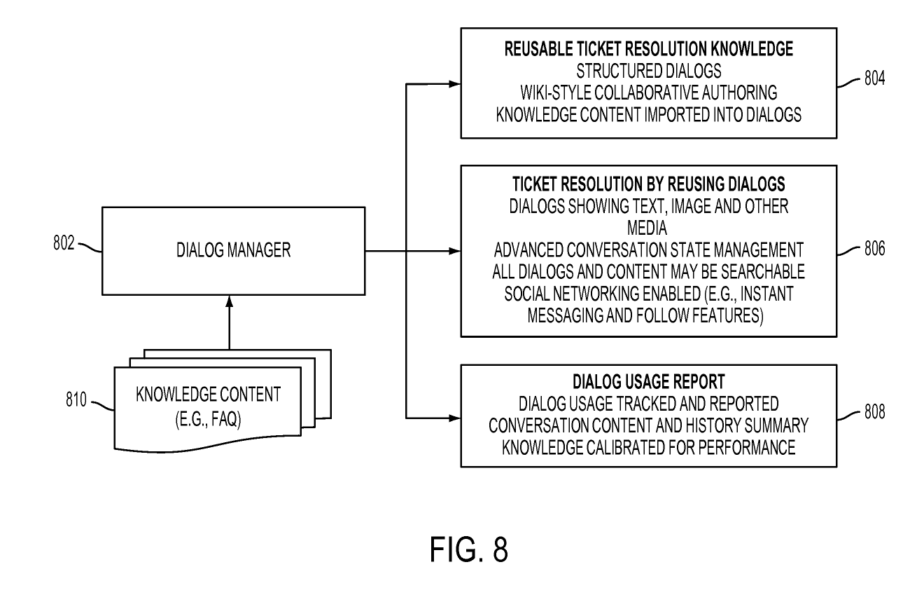

FIG. 8 is a diagram that illustrates an overview of an example dialog manager. A dialog manager 802 is an application or a tool, for instance, which can be web-based, for documenting, organizing and reusing procedural knowledge as dialogs. In a web-based dialog manager, no software installation is needed. A dialog manager 802 may incorporate artificial intelligence techniques. A dialog manager 802 may document problem or ticket resolution knowledge in dialogs by importing knowledge content, which may be in the form of frequently asked questions and may include corresponding answers. Problem or ticket resolution may be effected (i.e., problems describes in the ticket may be resolved) by searching the dialogs (knowledge base). A dialog manager 802 may facilitate reducing the number of tickets, reducing resolution time, lowering human labor cost with ticket resolution knowledge reuse, and thus improve overall profit margin for an organization.

A dialog manager 802 may provide capabilities for reusable ticket resolution 804, by reusing knowledge which may be structured as dialogs, and which may be authored by different authors similar to crowd sourced style of writing. Acquired knowledge content (authored by different authors) may be imported into dialogs. Resolution of tickets or problems may be done by reusing dialogs 806. Dialogs may contain and show text, image and other media, providing for advanced conversation state management capabilities. All dialogs and content may be searchable. Social networking may be enabled (e.g., instant messaging and follow features). A dialog manager 802 may also support dialog usage reporting capabilities 808. Dialog usage may be tracked and reported. Reports of conversation content and history summary may be generated.

A dialog manager 802 uses knowledge content (e.g., frequently asked questions (FAQ)) when available. If knowledge is yet to be defined it can be created.

A dialog manager 802 may further comprise a user interface, for example, a display, for interacting with a user, presenting the questions and answers of a dialog.

FIG. 9 illustrates a sample dialog that may be built and/or used in a dialog manager. A knowledge base of dialogs may be structured as a plurality of nodes, and edges that connect a pair of nodes. A top node (e.g., 902 or 904) may contain a question. The nodes (e.g., 906, 908, 910, 912, 914, 916) that connect directly or indirect via other nodes to the top node may contain procedures and/or further questions that lead to resolution of a problem. There may be multiple top nodes. A traversal path through the nodes via the connecting edges from the top node may make up a conversation or procedures to resolving a problem, a ticket or the like. A conversation thread, for example, provides a pathway through a dialog graph. An example of a thread or conversation thread may be through nodes 902, 908, 912 and 916. A conversation state refers to a set of threads that are active.

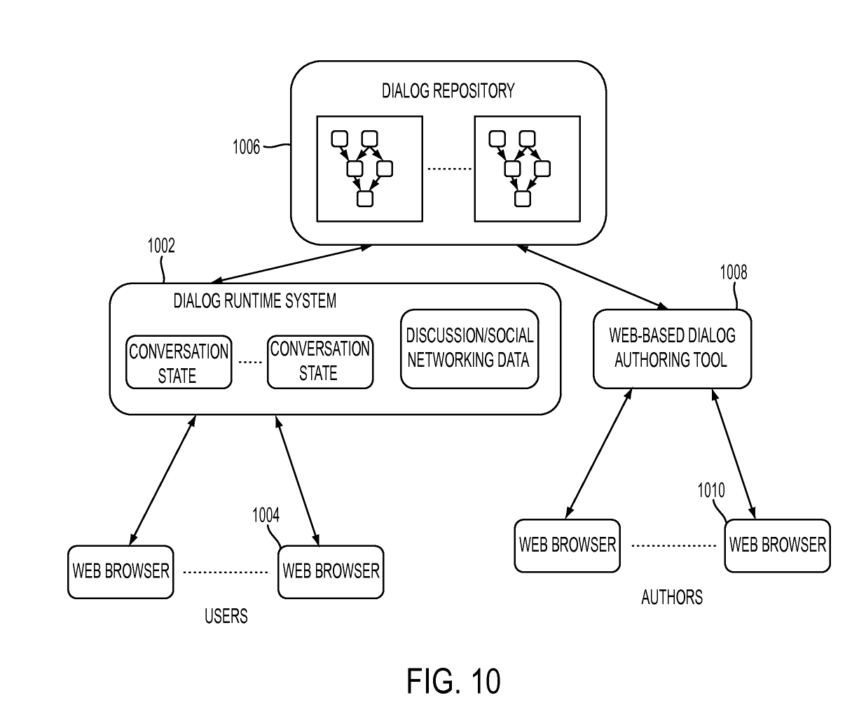

FIG. 10 illustrates an example dialog manager system. A user may run or execute a dialog manager runtime system 1002 via a web browser 1004. The dialog manager runtime system searches a dialog repository 1006 and generates a conversation (conversation state). A user may add and/or define any social networking data, e.g., data from social media that discuss the current problem. Social discussion among the users may also be tagged or linked to any dialog or node. The dialog manager system may also comprise an authoring tool 1008 that enables authors, for example, via a web browser 1010, to create and store a dialog in the dialog repository 1006. The authoring may be performed in various modes. For example, in document-based authoring, a plurality of dialogs may be authored by (semi-)automatically extracting nodes and links from word processor, spreadsheet and graphical documents. In another aspect, text documents may be generated out of dialogs authored with the dialog manger authoring tool 1008. Such text documents may be in an electronic editor document format, a hypertext markup language format, e.g., with embedded internal links, etc. The authoring may also be enabled via a touch screen interface. For instance, a plurality of dialogs as a directed acyclic graph comprising nodes and edges may be displayed in a touch screen interface allowing one or more authors to explore and navigate dialogs in the repository 1006 by using visual and touch operations such as zooming, panning, fisheye, etc., and to similarly edit one or more dialog by merging nodes, panning nodes, adding/removing edges between nodes, etc., by using the touch operations. Authoring may be enabled via real-time collaboration. For example, the authoring system may allow two or more authors to work (create, modify) on a dialog in the dialog repository in real time with the changes merged, synchronized and displayed in real time. Indexing of content and crowd-sourcing for content authoring may be enabled, for instance, providing capabilities to categorize and index nodes in a dialog repository by topic and providing shortcuts in choosing subareas of authoring and questioning. Classification algorithms may be used for such categorizing and indexing of nodes by topic.

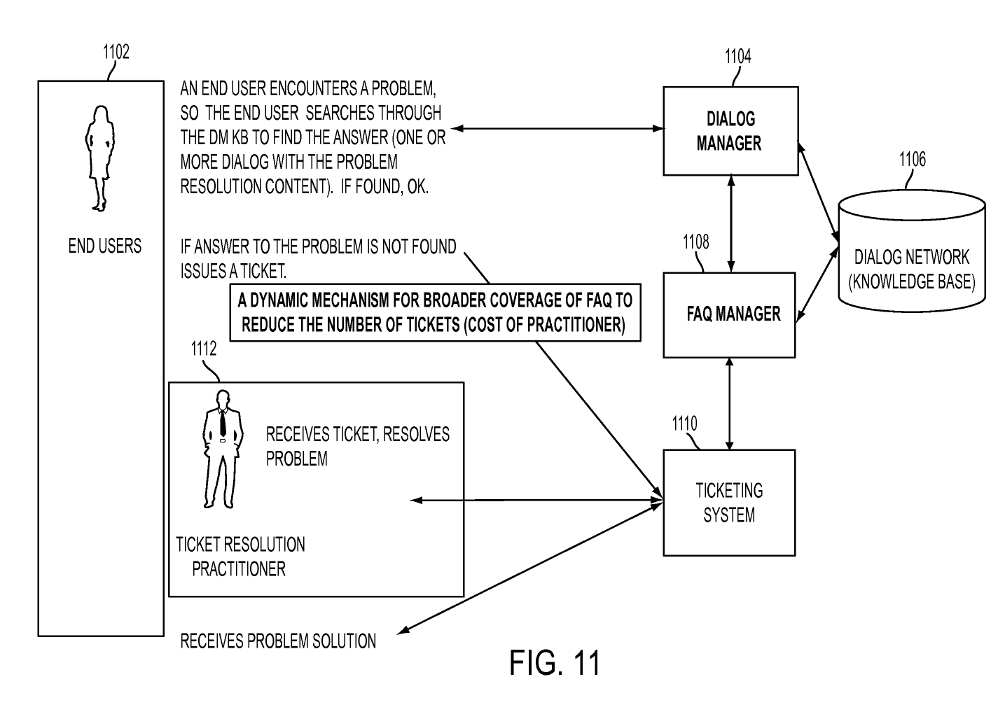

FIG. 11 illustrates a general overview of an example context in which a methodology of the present disclosure may be employed. An end user 1102 of a product (e.g., an electronic product, computer hardware, computer software, or another product) may encounter a problem. The end user 1102 may run or execute a dialog manager 1104, and via the dialog manager search through a dialog manager knowledge base 1106 to find a solution to the problem. A component of the dialog manager 1104, an FAQ manager 1108, may build a conversation state using dialog data extracted from the dialog network, that leads to a resolution of the problem. In building the conversation state associated with the problem, if the problem is a new problem not related to any resolution data stored currently in the knowledge base 1106, the dialog manager and/or the FAQ manager may further determine a best alternate dialog, as will be described in more detail below. In this way, a dynamic mechanism for broader coverage of FAQ may be provided that reduces the number of tickets that need further attention by a ticket resolution practitioner. In the event the problem cannot be resolved, a ticket may be issued to the ticket handling system 1110, which then may present the ticket to a ticket resolution practitioner 1112 who might manually attempt to resolve the problem. In another aspect, a problem ticket may be issued to a ticketing system 1110, which may automatically search for a solution using a methodology of the present disclosure. In the event no solution is found, the ticketing system may redirect the ticket to a practitioner 1112. The dialog manager 1104, FAQ manager and ticketing system may comprise computer executable components that execute on a computer processor for performing respective functionalities.

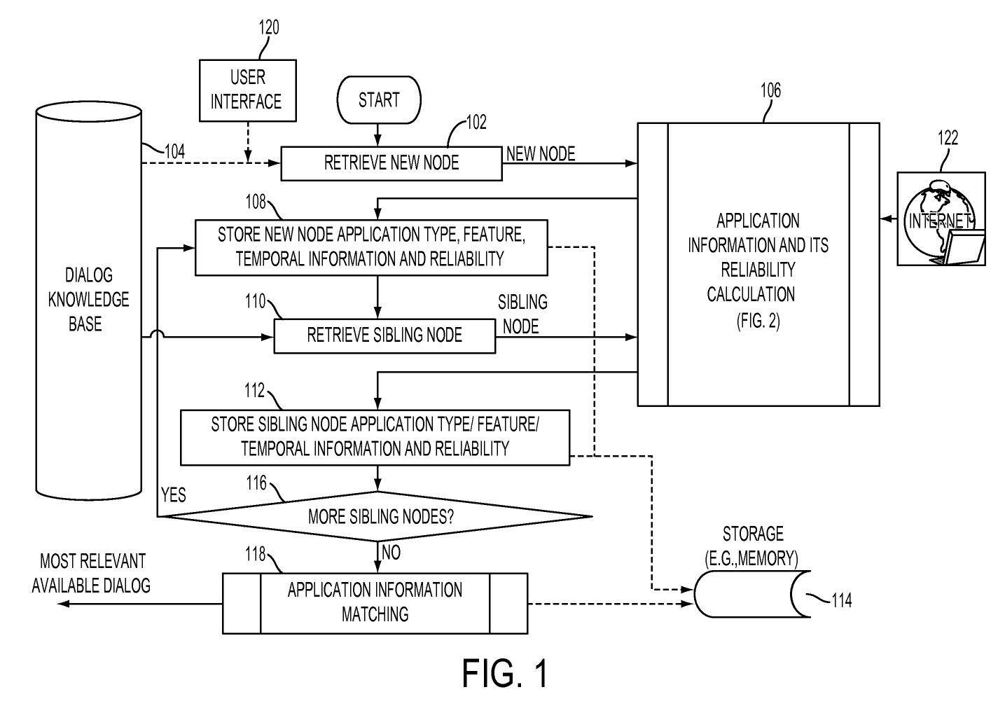

FIG. 1 illustrates an overall process flow of a method in one embodiment of the present disclosure for determining an available alternate dialog. The flow may be performed as real-time processing. In another aspect, non-real-time processing is also applicable. In the below description, “an application” is used as an example product for which a problem resolution is sought. It should be understood, however, that the methodologies of the present disclosure may apply to resolving problems associated with other products and services.

At 102, a new node is retrieved. In one aspect, the new node may be retrieved from a dialog knowledge base 104. An example of a new node incorporated in a dialog knowledge base is shown in FIG. 7 as reference item 704. Initially, the new node would not be mapped to other nodes (e.g., without dashed line to 706) since it is new and does not have a dialog or dialog network associated with it. The new node may comprise an application name, e.g., “XYZ EIM”. In another aspect, the new node may be received from a user, for example, via a user interface 120. For example, a user working with a dialog manager may be allowed to enter an application name via a user interface associated with the dialog manager.

Thus, generally at 102, a product identifier may be received from which a search may be performed to determine information and its reliability.

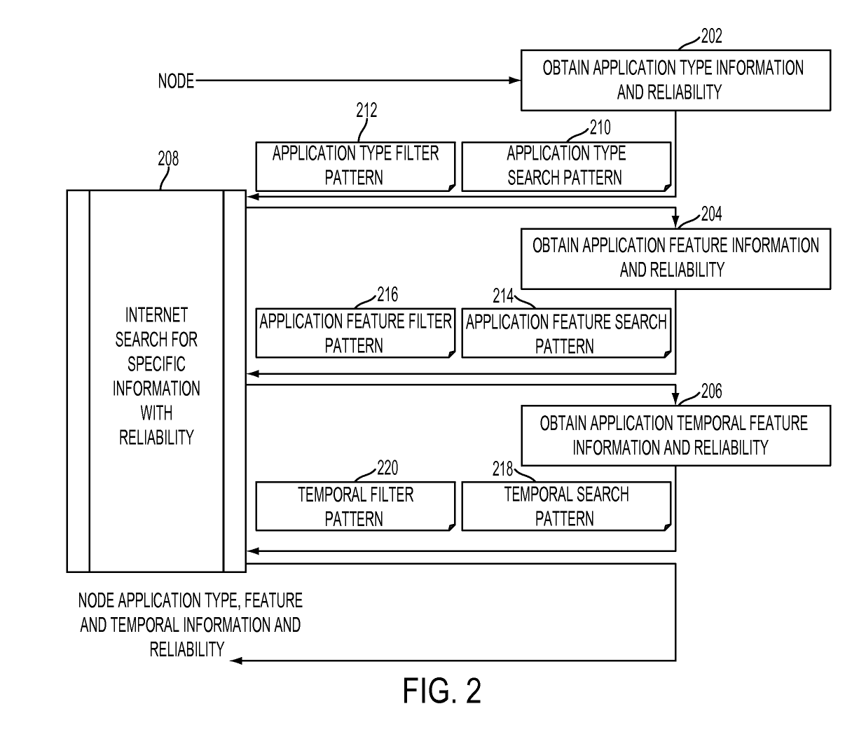

At 106, application or product information and reliability associated with the new node are determined, for example, as will be explained further with respect to FIG. 2. The information and reliability associated with a node may be performed based on available data, e.g., available via the Internet 122.

At 108, based on the determination made at 106, information such as the new node's application type, feature, temporal information and reliability is stored, for example, in memory 114. The storage may be temporary. In another aspect, all or part of the information may be stored more permanently, e.g., on one or more storage devices such as hard disks, flash memory, or other storage media or devices.

At 110, one or more related applications or products determined to be related to the given application or product may be retrieved. For example, a sibling node of the new node is retrieved from the dialog knowledge base 104. The sibling node retrieved at 110, for example, shares the same parent node as the new node. A sibling node is related to the given node because they share a parent node. For example, referring to the example shown in FIG. 7, a sibling node of a node labeled XYZ EIM 704 would include XYZ RS node 706. Another sibling node would include XYZ MDM node 708, which all share the same parent node, XYZ Business Suite node 702. To retrieve a sibling node, a tree structure of nodes with each node representing an application or product, for instance, stored in the dialog knowledge base 104 may be searched by the tree structure to identify a node that is a sibling node to the new node. Thus, for example, information about related applications or products may have been previously stored, in a data format (e.g., tree structure of nodes as shown in FIG. 7 or another format).

As in the new node, information and reliability associated with a related application or product (e.g., sibling node) is calculated, for instance, at 106. The information comprises type, feature and temporal information associated with the related product.

At 112, information about the related application or product (e.g., sibling node) such as the application type, feature, temporal information and reliability, for example, as determined at 106 is stored to memory 114.

In one aspect, the storing of the information associated with the new node at 108 and information associated with the sibling node at 112 may be to a temporary storage or memory and/or to a more permanent storage.

At 116, it is determined whether more related applications or products (e.g., sibling nodes) exist. For example, the knowledge base 104 that may comprise a tree structure of nodes that represent applications (e.g., see FIG. 14) may be traversed and searched to identify one or more nodes that have the same parent node as the new node. If more related application or product (e.g., sibling node) is found, the processing returns to 110. If all related applications or products (e.g., sibling nodes) have been processed, at 118, application or product information matching is performed to determine the most relevant or best available dialog.

Thus, for example, at least one of the one or more related products is selected that has the related product information that most closely matches the given product information (shown as new node at 102). A dialog network from the knowledge base, that is associated with the selected related product, may be presented for resolving the problem associated with the given product (shown as new node at 102).

In one embodiment, the matching at 118 may perform an optimal related product (sibling node) selection algorithm as follows. From the list of information for application type, feature and temporal information, obtained at 106, the most relevant related product (sibling node) is matched. For the new node uₙ, for example, the processing at 106 obtains the application type, feature and temporal information, for example, determined to have the highest reliability score. That information is compared to each of the sibling nodes' corresponding information. A sibling that has the closest matching information is selected, and that selected sibling's dialog network (a set of questions, answers and/or procedures) is returned as the most relevant available dialog for the new node.

For example, given uₙ's information, and it reliability factor, reliability(uₙ), the strength of match between uₙ and a sibling node, uₖ, k=1 to N, where N is the number of siblings identified at 110, 112 and 116, can be given by:

t(uₙ,uₖ)=reliability(uₖ)/distance(uₙ,uₖ)

where t(uₙ,uₖ) represents the strength of match.

For example, for the new node uₙ the kth data of information uₖ and its reliability reliability(uₖ), the strength of matching between uₙ and uₖ t(uₙ,uₖ) can be given by dividing the reliability(uₖ) by the distance(uₙ, uₖ).

Here, the distance(uₙ, uₖ) represents the distance in value by matching the list of information in uₖ and uₙ. For example, for temporal information the distance can be the difference in months. For application types or features, word match can be scored as a predefined value.

The node which is the biggest value for t( ) is the most relevant available node (opt_k). Opt_k represents k-th sibling out of 1 to N siblings:

$$opt\_k = arg {max}_{{u}_{n} , {u}_{k} ∈ N}^{{u}_{k}} \{ t ( {u}_{n} , {u}_{k} ) \}$$

FIG. 2 illustrates in one embodiment a method for application information retrieval and reliability calculation. At 202, application type information and reliability is obtained. For example, an Internet search 208 is performed for specific information associated with the application (or product) retrieved or entered as a new node. In another aspect, another existing database may be searched rather than or in addition to the Internet. A search for an application type may utilize an application type search pattern 210, which may comprise the identifier or the name of the specified application or product. Such search may return documents available on the Internet (e.g., different URL sites) that describe or have reference to the application (or product). The returned documents are filtered by application type filter pattern 212 to determine the type of the specified application. For example, consider a specific application as an ABC word processor application, the application type filter pattern 212 needs to determine that the type of the ABC word processor application is “word processor.” For instance, using predefined sets of application types, e.g., “word processor”, “spreadsheet”, and creating string search patterns (e.g., “ABC is a wordprocessor” or “wordprocessor ABC is”) incorporating such application types, it is possible to determine the type of application.

Reliability for this determined type may be computed or determined based on the source of the returned results, e.g., the domain name (URL link) of the search results.

At 204, application feature information and reliability are obtained. For instance, application feature search pattern 214 looks for features associated with the type of this application, e.g., word processor, e.g., by performing an Internet search at 208. Based on the results returned from the search, application feature filter pattern 216 identifies exact features. For instance, for an application that is of type word processor, the features maybe predefined such as “edit”, “print”, “copy”, “paste”, and other features. Based on these features, a string search pattern such as “ABC can edit”, “ABC has the feature to edit”, “edit feature of ABC”, may be used to as application feature filter pattern and perform a search. Based on the returned results, it can be determined whether those features are actually related to application ABC. In this way, it is possible to retrieve the features of ABC.

At 206, application temporal feature information and reliability are obtained. For instance, Internet search may be performed at 208 using a temporal search pattern 218, looking for temporal information associated with the application. Temporal filter pattern 220 is used to filter the temporal information returned from the search. The processing shown at 208 looks for specific information and computes the reliability associated with the returned results.

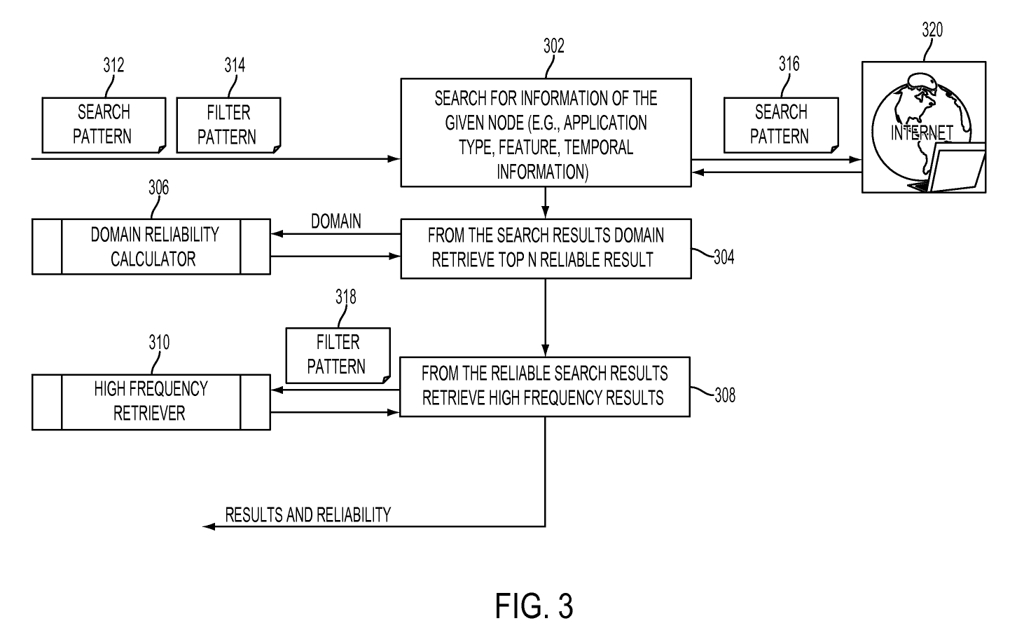

FIG. 3 illustrates in one embodiment a method for application information retrieval and reliability computation, for example, shown at 208. At 302, using the search pattern 312 and filter pattern 314, application information of a given node is searched for. The application information here may be for application type, application feature, or application temporal information, depending on in which context the functionality shown in FIG. 3 is invoked (e.g., see FIG. 2). For instance, the search pattern 315 is used as an input to a search, e.g., on the Internet 320. The search on the Internet 320, e.g., searches the URLs available on the Internet for documents that contain the search pattern 316. Search patterns 312 and 316 are the same patterns. Search pattern 312 is used for searching the Internet and the filter pattern 314 (may be referred to as a first filter pattern) is used to filter the target string (application type, feature or temporal information) from the search results. Filter pattern 314 retrieves the set of target strings from the search result. Filter pattern 318 (may be referred to as a second filter pattern to distinguish from the filter pattern shown at 314) is used to filter the most reliable results from all the target strings. This basic mechanism is common for application type, feature and temporal information.

At 304, from the results returned by the search at 302, top N reliable results are retrieved. N is a number that can be configured, for example, by a user, a programmer or an administrator, or another. Reliability of a result may be computed by domain reliability calculation processing shown at 306.

At 308, from the reliable search results, high frequency results are retrieved. High frequency results may be retrieved by a high frequency retriever processing at 310. A filter pattern 318 may be used to perform the processing at 310. Filter pattern 318 filters the most reliable results from the list of target strings. An example of this pattern may comprise a frequency threshold, e.g., that filters strings that have occurred a “threshold” number of times.

The processing shown in FIG. 3 returns results (e.g., type, feature, temporal information) and associated reliability of such information.

Application retrieval and reliability computation are further described with the following example. The example shows temporal information retrieval and reliability computation. For instance, the processing shown at 302 may be searching for timing information of a given node (application or product). From the search query of a given syntax pattern, search can be conducted to the Internet. An example of search query for temporal information may be “ABC EIM˜release” “ABC EIM˜released˜”. The processes of “Obtain Application Type Information and Reliability” 202, “Obtain Application Feature Information and Reliability” 204 and “Obtain Application temporal feature Information and Reliability” 206 shown in FIG. 2, may use the same functionality shown in FIG. 3, with different search pattern 312, filter pattern 314 and filter pattern 318 specified for type, feature and temporal information.

From the search results in which the temporal information available, the reliability of the domain of the temporal information may be calculated (e.g., at 306) and those meeting a given reliability criteria or threshold may be selected.

A reliability of a domain may be predefined, based on known reliable domains. In another aspect, for those domains that do not have known or predefined reliability factor or score, a reliability of a domain may be computed by dividing (number_of reliable_links_to +number_of_reliable_links_from) by (total_number_of_links_to +total_number_of links_from):

$$\frac{( \begin{matrix}number\_of \_reliable \_links \_to + \\ number\_of \_reliable \_links \_from\end{matrix} )}{( total\_number \_of \_links \_to + total\_number \_of \_links \_from )}$$

“Number_of_reliable_links_to” represents the number of reliable domains found in one or more Internet documents (e.g., a hypertext document) of the given domain (whose reliability is being computed), to which the Internet documents reference or link, for example, with annotations such as hypertexts. A reliable domain refers to a domain or location (e.g., uniform resource location (URL)) known or predefined to be reliable. A domain may be identified by selected levels of URL (e.g., one or more levels).

“Number_of_reliable_links_from” represents the number of reliable domains which link this subject domain. For example, a reliable domain's document may reference a document of this given domain.

“Total_number_of links_to” represents the total number of domains or locations found in one or more Internet document (e.g., a hypertext document) of the given domain, to which the Internet documents link, e.g., has a hypertext reference to other domains or URLs.

“Total_number_of links_from” represents the total number of domains or locations found in one or more Internet documents (e.g., a hypertext document) of the given domain, from which the Internet documents link, e.g., those that have hypertext reference to this given domain.

Continuing with the temporal information example, from the reliable domains, top N search results are obtained at 304. From those results, temporal information may be retrieved. For example, from the search results, regular expression technique or other text analysis techniques can be adopted to extract the temporal information. For example, text patterns such as “MM/YYYY”, “MM/DD/YYYY”, or other time information pattern may be looked for in the document search results returned at 304. Briefly M represents month, D represents date, Y represents year. An example text may include “3/2010”, “5/2010”, “3/2008”. Other date and time, or time information search patterns may be provided for performing the search.

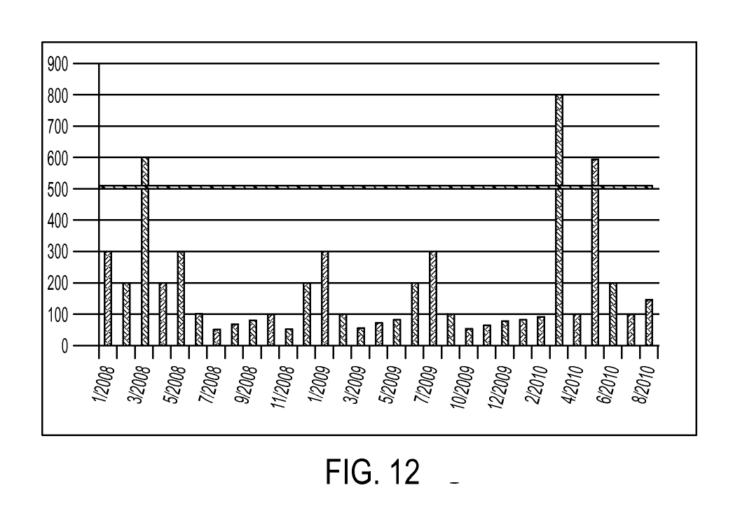

Using the results obtained at 304 (e.g., top N reliable results from domains determined to be reliable at 306), histogram of the results (e.g., temporal information) may be created by frequency. FIG. 12 shows a sample histogram. The horizontal axis shows different temporal information retrieved related to the given node (application or product). The vertical axis may represent a number of occurrences for each of the different temporal information. The temporal information that occurs more frequently in the results would have higher peak in the histogram compared to those that occur less frequently. Top P peaks of temporal information or those that meet a given criterion may be selected. P is a number that can be configured, for example, by a user, a programmer or an administrator, or another. An example of a given criterion or a threshold may be the number of occurrences, e.g., 500.

The frequency, which is another level of reliability and which can be obtained against the total sample number of temporal information retrieved at 304 (e.g., the top N reliable result), can be used for reliability, e.g., as a reliability score associated with a particular result. For example, if “3/2010” makes up 55% of the total number of temporal information, the reliability score associated with this temporal information may be set as 55; if “4/2009” makes up 15% of the total number of temporal information, the reliability score associated with this temporal information may be set as 15. The obtained one or more temporal information and their reliability are returned. For instance, the temporal information that is returned may be one or more of the information that meet a criterion or a threshold. An example of a threshold is a total number of occurrences, a percentage of occurrences, etc.

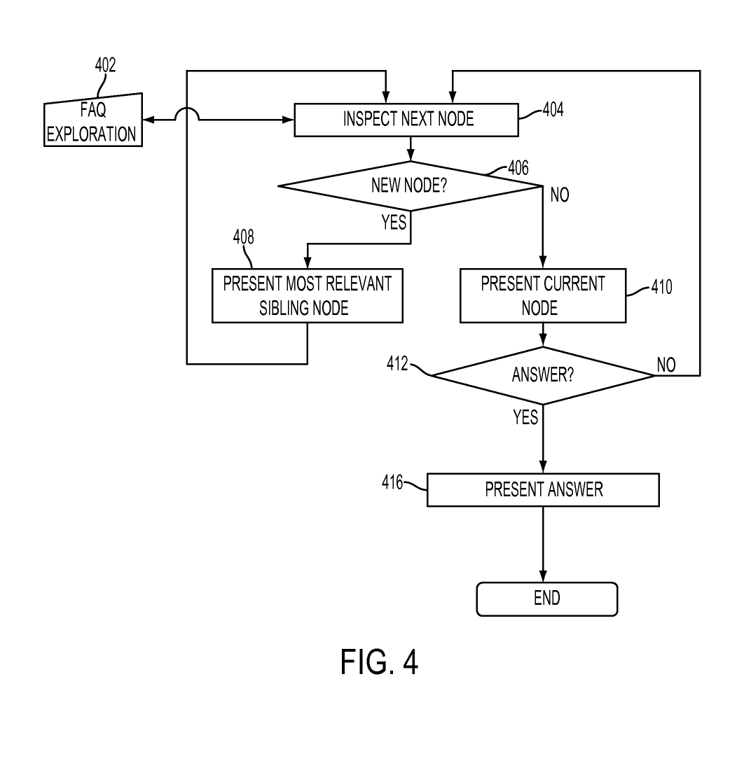

FIG. 4 illustrates dialog exploration in one embodiment of the present disclosure. Dialog exploration allows an end user, e.g., of a dialog manager, to explore frequently asked questions (FAQ) at 402, for example, navigate through a dialog manager knowledge base. If a new node is encountered or specified, the methodology of the present disclosure, e.g., as described above, may determine and present the most relevant available node and determine whether an answer can be obtained for the end user associated with the new node.

At 404, the navigation through the knowledge base inspects a next node. At 406, it is determined whether the next node is a new node. If the node is a new node, the most relevant sibling node is presented at 408, e.g., as described above with reference to FIGS. 1, 2 and 3. The logic returns to 404, where the most relevant sibling node is inspected as the next node. If the next node is not a new node (this would occur after the logic returns from 408 since the presented sibling node would not be considered a new node), the current node (e.g., which may include the presented sibling node) is presented at 410, which may comprise navigating through a dialog network associated with this node (questions, answers, and/or additional procedures associated with this node) for resolving the end user's question or problem. At 412, it is determined whether an answer has been found in the dialog. If not, the processing logic returns to 404 where the next node is inspected looking for an answer. Otherwise, if an answer is found, the answer is presented to the end user at 416.

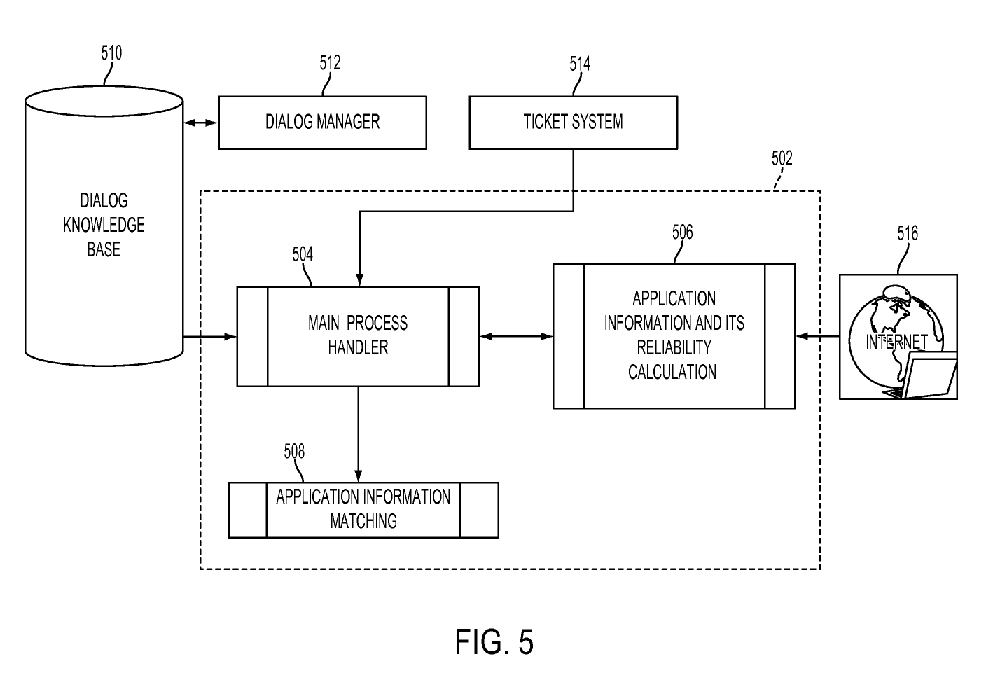

FIG. 5 is a diagram illustrating a system for determining a best available dialog in one embodiment of the present disclosure. The component shown at 502 illustrates components that implement a methodology of the present disclosure. Such components may include computer implementable modules, e.g., software application running on one or more computer processors (or processing units) and/or a specially programmed processor to perform the methods. A main process handler 504 processes a new node, e.g., entered via a ticket system 514. The new node specifies a product or application or another item, in relation to which an answer is being sought or a problem is to be resolved. In another aspect, a new node to be processed may come from a dialog knowledge base, e.g., in navigating or traversing through the nodes of a knowledge base, for example, via a dialog manager 512 that allows a user to navigate through a question and answer procedure associated with a product or an application.

The main process handler 504 determines the information such as the type, feature and temporal information associated with the new node and the reliability score for the obtained information. An information and reliability calculation component 506 may perform this determination based on the data search performed on the Internet 516. The main process handler 504 also identifies a plurality of sibling or other related nodes of the new node from the dialog knowledge base 510, and similarly obtains the information such as the type, feature and temporal information associated with the sibling nodes and their reliability scores using the information and reliability calculation component 506. Based on the information and reliability calculation associated with the new node and the sibling or other related nodes, the main process handler 504 performs information matching using an information matching component at 508. The information matching component may perform the optimal sibling node selection algorithm described above with reference to FIG. 1 at 118.

In one aspect, once the information and associated reliability for the new node and the sibling nodes are determined and stored, the information retrieval and reliability computation need not be performed for those nodes. For instance, in a subsequent round of execution for determining a best available dialog for a new node, if the identified sibling nodes already have the associated type, feature and temporal information and reliability information, the information and reliability calculation (e.g., at 506) need not be performed for those sibling nodes. Rather, the stored information may be used to compare with the information retrieved for the new node, in determining the best available dialog.

Data format of a ticket from a ticket system 514 may include, but are not limited to, data fields for a ticket identifier, ticket severity, ticket category, ticket sub-category, and ticket description. This data may be shared among ticket systems and FAQ Manager system or tool. FAQ Manager allows accessing the ticket data either manually by invoking an FAQ editor (that maintains the Dialog Network) or automatically by clustering the ticket data to reflect to the Dialog Network.

Data format of a dialog network, e.g., stored in a dialog knowledge database 510, may include, but not limited to, data fields for a FAQ node, a Link to Child node, Condition of Link to child node (description of an edge that connects the node to the child node), and Link to Parent node.

Internet (and/or other data sources for applications or products) format, e.g., format of data retrieved from the Internet 516, may include, but are not limited to, Text information, URL (including domain), and Reliability score of domain.

In the above description, a new node was described as being an application, and a set of dialogs including questions/procedures to resolving a question or a problem associated with the application. However, it should be understood that the methodologies of the present disclosure may apply to any other products or items, including e.g., computer hardware products.

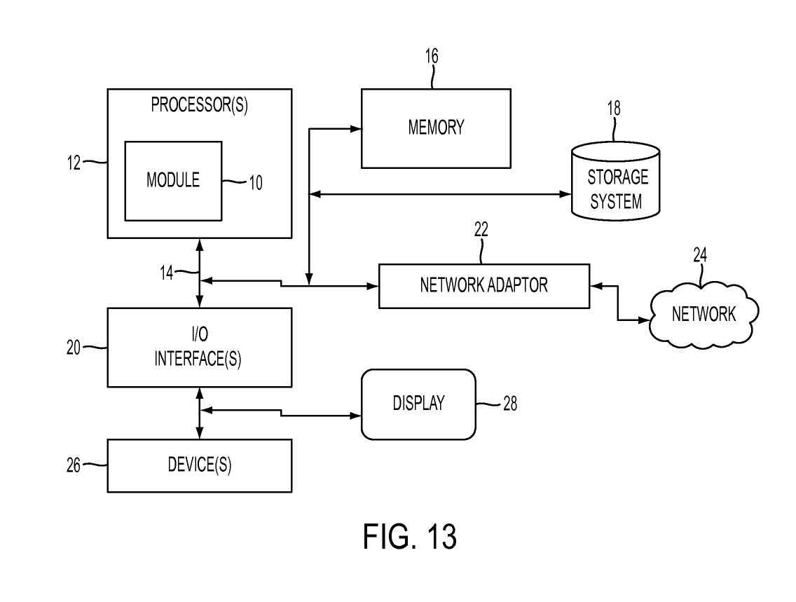

FIG. 13 illustrates a schematic of an example computer or processing system that may implement a system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 13 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method for recommending problem resolution knowledge, comprising:
receiving an identifier associated with a given product for a problem resolution, wherein the problem resolution associated specifically with the given product is not available in a knowledge base that comprises a network of dialogs established for problem resolutions;
determining, by a processor, given product information associated with the given product by searching an information network based on the identifier associated with the given product, and reliability associated with the given product information, the given product information comprising a type of the given product, one or more features associated with the given product, and temporal information associated with the given product;
retrieving from the knowledge base one or more related products determined to be related to the given product;
determining, by the processor, related product information associated with each of the one or more related products, and reliability associated with the related product information, the related product information comprising a type of the related product, one or more features associated with the related product, and temporal information associated with the related product;
selecting at least one of said one or more related products that has the related product information that most closely matches the given product information; and
presenting a dialog network from the knowledge base for the problem resolution associated with the given product, the dialog network associated with said at least one of said one or more related products.

2. The method of claim 1, wherein the information network comprises at least the Internet.

3. The method of claim 1, wherein the determining of the given product information further comprises selecting a predefined number of search results of the searching from domains that meet a reliability criterion, from which to determine the given product information.

4. The method of claim 1, wherein the determining of the related product information further comprises selecting a predefined number of search results of the searching from domains meeting a reliability criteria, from which to determine the related product information.

5. The method of claim 1, wherein the reliability associated with the given product information is computed based on whether domains returned by said searching of the information network based on the identifier associated with the given product, are determined to be reliable.

6. The method of claim 1, wherein the reliability associated with the related product information is computed based on whether domains returned by said searching of the information network for said one or more related products, are determined to be reliable.

7. The method of claim 1, wherein the determining of the given product information further comprises selecting results of said searching of the information network based on the identifier associated with the given product, that have higher occurrence frequency of terms.

8. The method of claim 1, wherein the knowledge base further comprises a logical graphical tree structure of nodes and edges, with a node representing a product and an edge between two nodes representing a relation between products represented by the two nodes,
wherein said retrieving from the knowledge base one or more related products determined to be related to the given product comprises retrieving a sibling node to a node that represents the given product in the graphical tree structure.

9. The method of claim 1, wherein the temporal information associated with the given product comprises product release time associated with the given product.

10. The method of claim 1, wherein the given product includes a computer application.

11. A computer readable storage medium storing a program of instructions executable by a machine to perform a method of recommending problem resolution knowledge, the method comprising:
receiving an identifier associated with a given product for a problem resolution, wherein the problem resolution associated specifically with the given product is not available in a knowledge base that comprises a network of dialogs established for problem resolutions;
determining, by a processor, given product information associated with the given product by searching an information network based on the identifier associated with the given product, and reliability associated with the given product information, the given product information comprising a type of the given product, one or more features associated with the given product, and temporal information associated with the given product;
retrieving from the knowledge base one or more related products determined to be related to the given product;
determining, by the processor, related product information associated with each of the one or more related products, and reliability associated with the related product information, the related product information comprising a type of the related product, one or more features associated with the related product, and temporal information associated with the related product;
selecting at least one of said one or more related products that has the related product information that most closely matches the given product information; and
presenting a dialog network from the knowledge base for the problem resolution associated with the given product, the dialog network associated with said at least one of said one or more related products.

12. The computer readable storage medium of claim 11, wherein the information network comprises at least the Internet.

13. The computer readable storage medium of claim 11, wherein the determining of the given product information further comprises selecting a predefined number of search results of the searching from domains that meet a reliability criterion, from which to determine the given product information.

14. The computer readable storage medium of claim 11, wherein the determining of the related product information further comprises selecting a predefined number of search results of the searching from domains meeting a reliability criteria, from which to determine the related product information.

15. The computer readable storage medium of claim 11, wherein the reliability associated with the given product information is computed based on whether domains returned by said searching of the information network based on the identifier associated with the given product, are determined to be reliable.

16. The computer readable storage medium of claim 11, wherein the reliability associated with the related product information is computed based on whether domains returned by said searching of the information network for said one or more related products, are determined to be reliable.

17. The computer readable storage medium of claim 11, wherein the determining of the given product information further comprises selecting results of said searching of the information network based on the identifier associated with the given product, that have higher occurrence frequency of terms.

18. A system for recommending problem resolution knowledge, comprising:
a processor;
a knowledge base coupled to the processor and storing a network of dialogs for problem resolutions;
a main process handler module operable to execute on the processor, and further operable to receive an identifier associated with a given product for a problem resolution, wherein the problem resolution associated specifically with the given product is not available in the knowledge base,
the main process handler module further operable to retrieve from the knowledge base one or more related products determined to be related to the given product;
an information and reliability calculation module coupled to the main process handler module, and operable to execute on the processor, the information and reliability calculation module further operable to determine given product information associated with the given product by searching an information network based on the identifier associated with the given product, and reliability associated with the given product information, the given product information comprising a type of the given product, one or more features associated with the given product, and temporal information associated with the given product,
the information and reliability calculation module further operable to determine related product information associated with each of the one or more related products, and reliability associated with the related product information, the related product information comprising a type of the related product, one or more features associated with the related product, and temporal information associated with the related product;
an information matching module coupled to the main process handler module and operable to execute on the processor, the information matching module further operable to select at least one of said one or more related products that has the related product information that most closely matches the given product information,
the main process handler module further operable to present a dialog network from the knowledge base for the problem resolution associated with the given product, the dialog network associated with said at least one of said one or more related products.

19. The system of claim 18, further comprising a user interface module via which a user is allowed to specify the identifier associated with a given product for a problem resolution.

20. The system of claim 18, wherein the knowledge base further comprises a logical graphical tree structure of nodes and edges, with a node representing a product and an edge between two nodes representing a relation between products represented by the two nodes, wherein the main process handler module retrieves from the knowledge base as one or more related products determined to be related to the given product by retrieving a sibling node to a node that represents the given product in the graphical tree structure.
